(19) United States
(12) Patent Application Publication
(10) Pub. No.: US 2015/0363720 A1
(43) Pub. Date: Dec. 17, 2015

(54) AUTOMATED METRIC TRACKING FOR A BUSINESS

(71) Applicant: Vivint, Inc., Provo, UT (US)

(72) Inventor: Greg Fairbanks, Cedar Hills, UT (US)

(21) Appl. No.: 14/304,716

(22) Filed: Jun. 13, 2014

(51) Int. Cl. G06Q 10/06; G06Q 10/10

(52) U.S. Cl. CPC G06Q 10/0639; G06Q 10/109

(57) ABSTRACT

A computer-implemented method to automate metric tracking for a business is disclosed. The method may comprise observing customer data related to the business. The customer data may comprise at least one of a number of customers, customer purchases, or customer traffic. The observed customer data may be compared with a work schedule for personnel associated with the business. The work schedule may be based at least in part upon one or more scheduling parameters of the business. It may be determined if the observed customer data exceeds one or more scheduling parameters of the business. In some embodiments, at one personnel associated with the business may be alerted based upon the determining step when customer data exceeds one or more scheduling parameters. In some embodiments, the method may additionally alert a supervisor of the business based on the determining step when the customer data exceeds one or more scheduling parameters.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to the computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of technology in everyday life. Advancements in mobile devices and related mobile technology allow users to monitor their location, movement, and/or other aspects of everyday life. As technology expands into homes and businesses, opportunities exist for using technology for alternative purposes such as tasks related to automating business metric tracking.

### SUMMARY

According to at least one embodiment, a computer-implemented method to automate metric tracking for a business is disclosed. The method may comprise observing customer data related to the business. The customer data may comprise at least one of a number of customers, customer purchases, or customer traffic. The observed customer data may be compared with a work schedule for personnel associated with the business. The work schedule may be based at least in part upon one or more scheduling parameters of the business. It may be determined if the observed customer data exceeds one or more scheduling parameters of the business. In some embodiments, at one personnel associated with the business may be alerted based upon the determining step when customer data exceeds one or more scheduling parameters. In some embodiments, the method may additionally alert a supervisor of the business based on the determining step when the customer data exceeds one or more scheduling parameters.

In further embodiments, the customer data may be captured. At least one video camera may be installed at the business which may capture images of customer movement. Customer movement may be determined from the capturing, wherein movement may comprise entering or exiting the business. The number of customers present at the business may be gauged based on the determining. In some embodiments, scheduling parameters may be set, wherein the parameters comprise at least a ratio of personnel associated with the business and number of customers present at the business.

In alternative embodiments, the method may record customer data based upon the observing and may generate reports based on the recording. In some embodiments, the method may distribute the reports to at least one personnel associated with the business. The reports may help develop one or more scheduling parameters and one or more inventory parameters for pending time periods.

In further embodiments, the method may comprise identifying an unpredicted change in customer data, wherein the change may comprise a fluctuation in customer traffic or customer purchases. The method may request information from at least one personnel associated with the business to correlate the unpredicted change in customer data with an external event. The method may then record the unpredicted change in a database with the correlating external event information. The external event may be one of a conference, a sales event, a product release, inclement weather, or a social event. In some embodiments, the method may review the database for historical information and generate a report to send to at least one personnel associated with the business. The report may contain historical information for an upcoming time period.

In some embodiments, the method may producing a list of shift auxiliary options, wherein the shift auxiliary options comprise at least a list of acceptable auxiliary personnel. The options may be displayed to a supervisor of the auxiliary personnel. The method may receive a notification that an acceptable auxiliary personnel agreed to work.

In further embodiments, the method may capture point of sale data. Point of sale data may comprise at least one of items purchased, cost of items purchased, and relationship of items purchased to each other. The method may compare point of sale data to the work schedule and determine one or more trends between point of sale data and the work schedule. The one or more trends may capture profits or losses of the business. The method may generate a report based on the determining. The report may comprise at least the one or more trends.

According to another embodiment, an apparatus to automate metric tracking for a business is also described. The apparatus may include a processor, a memory in electronic communication with the processor and instructions stored on the memory of the processor. The processor may execute the instructions to observe customer data related to the business. The customer data may comprise at least one of a number of customers, customer purchases, or customer traffic. The processor may execute the instructions to compare the observed customer data with a work schedule for personnel associated with the business. The work schedule may be based at least in part upon one or more scheduling parameters of the business. The processor may execute the instructions to determine if the observed customer data exceeds one or more scheduling parameters of the business. In some embodiments, the processor may execute the instructions to alert at one personnel associated with the business based upon the determining step when customer data exceeds one or more scheduling parameters.

According to another embodiment, a computer-program product to automate scheduling for a business is also disclosed. The computer-program product may include a non-transitory computer-readable medium that may store instructions executable by a processor. The instructions may observe customer data related to the business. The customer data may comprise at least one of a number of customers, customer purchases, or customer traffic. The instructions may compare the observed customer data with a work schedule for personnel associated with the business. The work schedule may be based at least in part upon one or more scheduling parameters of the business. The instructions may determine if the observed customer data exceeds one or more scheduling parameters of the business. In some embodiments, the instructions may alert at one personnel associated with the business based upon the determining step when customer data exceeds one or more scheduling parameters.

The foregoing has outlined rather broadly the features and technical advantages of examples according to the disclosure such that the following detailed description may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of an example of another environment in which the present systems and methods may be implemented;

FIG. 3 is a block diagram of an example automated schedule module of the environments shown in FIGS. 1 & 2;

FIG. 4 is a block diagram of an example scheduling module of the environment shown in FIG. 3;

FIG. 5 is a block diagram of an example business metrics module of the environments shown in FIGS. 1 & 2;

FIG. 6 flow diagram illustrating a method to automate scheduling for a business;

FIG. 7 is a flow diagram illustrating another method to automate scheduling for a business;

FIG. 8 is a flow diagram illustrating an exemplary method of finding an auxiliary personnel;

FIG. 9 is a flow diagram illustrating another method to automate business metric tracking for a business;

FIG. 10 is a flow diagram illustrating another exemplary method to automate business metric tracking for a business;

FIG. 11 a block diagram of a computer system suitable for implementing the present systems and methods of FIGS. 1-10;

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to automated business metric tracking. More specifically, the systems and methods described herein relate to an automated system for alerting personnel associated with the business when thresholds or parameters are exceeded or satisfied. The alerts may be electronic. In one example, customer data may be observed and recorded including at least a number of customers, customer purchases, or customer traffic. In another embodiment, personnel may be alerted if customer data reaches set thresholds or parameters.

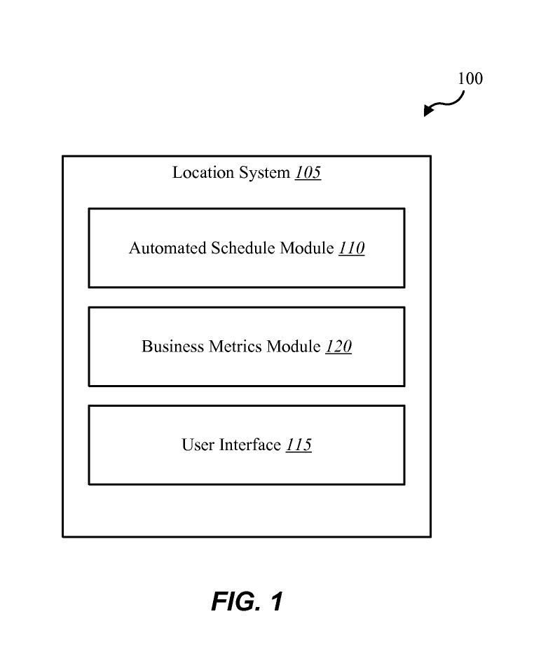

FIG. 1 is a block diagram illustrating one environment 100 on which the methods and disclosure may be implemented. The environment 100 may include a location system 105. The location system 105 may include an automated schedule module 110, a business metrics module 120, and a user interface 115. While FIG. 1 shows the automated schedule module 110, the business metrics module 120, and the user interface 115 included within the location system 105, these and other components of the environment 100 may be housed separately and operate independently while still working cooperatively with each other and other components of the location system 105.

The location system 105 may be associated with a commercial entity. For example, the location system 105 may be located at a business. The business may have at least one personnel associated with it. In some embodiments, the personnel may be an employee. The business may be any commercial business. In some instances, the business may be a restaurant, a retailer, a warehouse, a health-care provider, and the like. In some instances, a location system 105 may be present at multiple different locations associated with the same business. For example, the business may be part of chain, may have satellite offices, or the like. In other examples, the business may have multifunctional locations. For example, a business may have a warehouse, a manufacturing facility, an office space, a testing space and/or any combination thereof. In those embodiments, the environment 100 may have multiple location systems 105 for each business location. In other embodiments, one location system 105 may be present at a single location and may service all of the business's locations. When the term business is used herein, it encompasses all types of non-residential locations.

The location system 105 may be controlled by an administrator. The administrator may be a supervisor, personnel, business owner, CEO, employee, or some other professional associated with the location. In some embodiments, multiple people may be the administrator. For purposes of clarity, the term administrator used herein may encompass either a single individual or multiple individuals with equal access to the location system 105, personnel scheduling duties, and access to business metrics.

The automated schedule module 110 may be configured to observe and learn from the actions of personnel associated with the business and to create a schedule optimized for business needs. In some embodiments, personnel may interact with scheduling system via a mobile device. For purposes of clarity, personnel may refer to single personnel or multiple personnel. Additionally, the term manager may encompass a supervisor, business owner, administrator, or any personnel in charge of staffing solutions and capable of accessing business metrics. While the term manager will be used, it will be understood that it may encompass multiple managers.

In some embodiments, the automated schedule module 110 may be a mostly automated system requiring little to no external input. In other embodiments, the automated schedule module 110 may receive varying levels of input to shape and customize the automated schedule module 110 to meet the business needs. The user interface 115 may interact with the automated schedule module 110 and receive manager preferences, personnel preferences, business information and the like. In other embodiments, the user interface 115 may be integrated with the personnel's device or a manager's device.

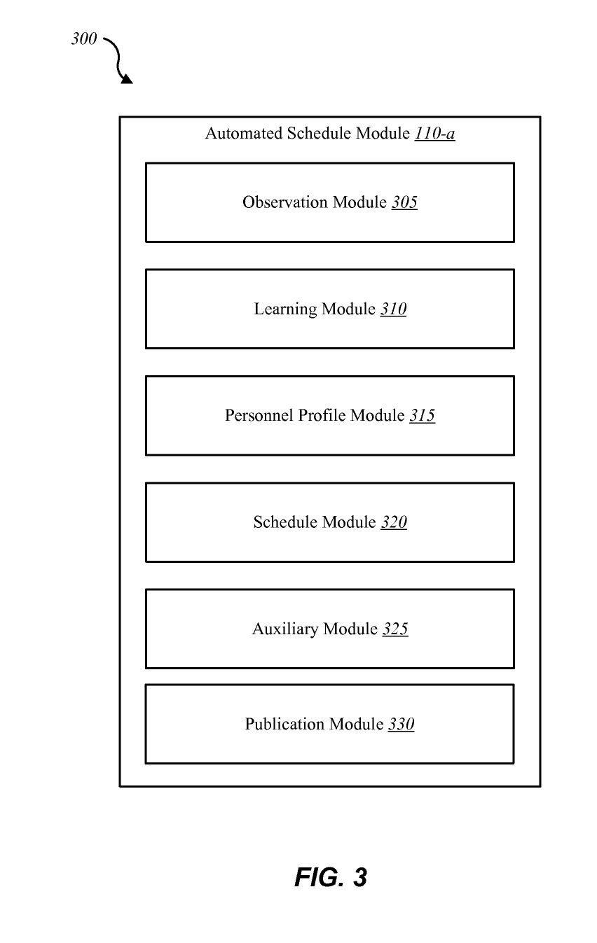

The automated schedule module 110, in addition to automating a work schedule, may have the capability to store and analyze personnel data, track business efficiency and profitability and other functions as described in further detail below with reference to FIG. 3. The automated schedule module 110 may also be capable of receiving communications from a remote device in response to the work schedule. The automated schedule module 110 may perform additional functions as discussed herein.

In some embodiments, the business metrics module 120 may be a mostly automated system requiring minimal input, or in some instances, may be a completely independently operational module. In some embodiments, the business metrics module 120 may allow a manager to determine which metrics are tracked. In other embodiments, the business metrics module 120 may present a menu or the like and allow a manager to optionally chose which metrics to track. In some embodiments, the business metrics module 120 may additionally allow personnel to set the types of alerts managers receive. In other embodiments, the alerts may be preprogrammed and the manager may set the thresholds or parameters which may trigger the alerts.

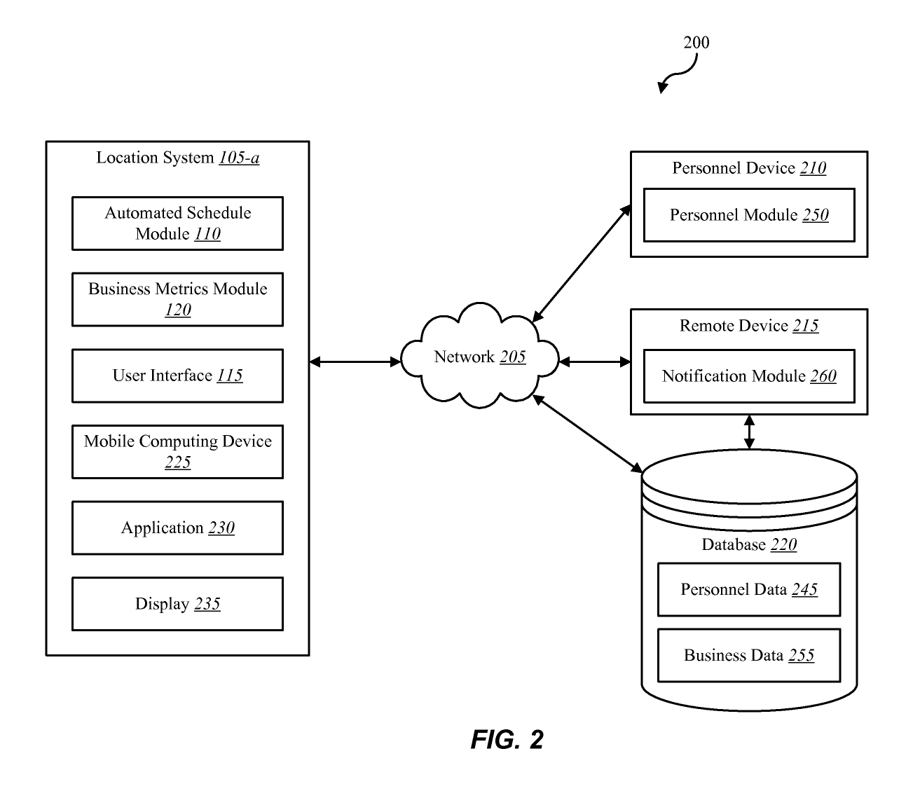

Referring now to FIG. 2, in some embodiments, an environment 200 may include the components of environment 100 described above, and may further include a network 205, a personnel device 210, a remote device 215, and a database 220. The location system 105-a may be one example of the location system 105 described above with reference to FIG. 1. The location system 105-a may include, in addition to the automated schedule module 110 and the user interface 115, a mobile computing device 225, an application 230, and a display 235. A database 220 may include (e.g., store) personnel data 245 and/or business data 255.

The location system 105-a may include various components and functionalities that work cooperatively with the automated schedule module 110, the business metrics module 120, and the user interface 115, and/or may operate independently of the automated schedule module 110, the business metrics module 120, and the user interface 115. In some embodiments, the application 230 may use the location system 105-a to perform tasks related to the automated schedule module 110 and/or the business metrics module 120.

In some embodiments, the mobile computing device 225 may include one or more processors, one or more memory devices, and/or a storage device. Examples of the mobile computing device 225 may include mobile computing devices, smartphones, personal computing devices, computers, servers, etc. The mobile computing device 225 may be operable independent of features of the automated schedule module 110 and the user interface 115. Alternatively, at least some functionality of the mobile computing device 225 may cooperate with and/or interface with the automated schedule module 110 and/or the user interface 115.

The application 230 may allow a user or manager to control (either directly or indirectly) an aspect of the property where the location system 105-a is located. In some configurations, the application 230 may also interface between, for example, the automated schedule module 110, the business metrics module 120, the user interface 115, the mobile computing device 225, or the display 235. Thus, the application 230, via the user interface 115, the display 235, and/or the mobile computing device 225, may allow managers to automate business metric tracking. Information or data associated with the application 230 and its operation may be saved according to the data storage methods described herein.

In some embodiments, a user may access the functions of the location system 105-a from the mobile computing device 225. For example, in some embodiments, the mobile computing device 225 includes a mobile application that interfaces with one or more functions of the location system 105-a (e.g., automated schedule module 110/business metrics module 120). Examples of the mobile computing device 225 may include a personal computing device (e.g., a laptop, desktop, etc.), a mobile computing device (e.g., tablet computing device, smartphone, etc.), and the like. The automated schedule module 110, the business metrics module 120, and/or the user interface 115 may be integrated with the mobile computing device 225 in the form of one or more personal computing devices (e.g., mobile devices, smartphones, and/or personal computing devices) to control aspects of the location and/or monitor activities of personnel (e.g., clock-in, clock-out, perform duties, job performance, scheduling, receive business metric alerts, etc.).

In some embodiments, the personnel device 210 may be a mobile device unique to a particular personnel. The personnel device 210 may include, for example, a personal computing device (e.g., laptop), a mobile computing device (e.g., tablet computing device, smartphone, etc.), a wearable device, a multi-purpose portable device, a multi-purpose pocket computer, or the like. The personnel device 210 may be in communication with the automated schedule module 110, the business metrics module 120, or other features and components of the location system 105-a via, for example, the network 205. The personnel device 210 may be capable of two-way communication with the automated schedule module 110, the business metrics module 120, and other features of the location system 105-a including, for example, receiving notifications from and sending information (e.g., notifications, time entry information, schedule information, auxiliary shift options, etc.) back to the automated schedule module 110, the business metrics module 120, or other features of the location system 105-a. The personnel device 210 may include a display and/or user interface. Notifications may be received on the personnel device 210 in the form of, for example, a text message, email, audible signal, picture, ping message, etc. The notifications received at the personnel device 210 may be in response to scheduling data which is generated via the automated schedule module 110, the business metrics module 120, and/or the user interface 115 and delivered to the remote device 215 and/or the database 220, or directly to the personnel device 210. The personnel device 210 may also include storage capability to store data such as personnel work data, notifications, schedules, contact information, and the like associated with their employment.

In some embodiments, the personnel device 210 may interact with the location system 105-a via an personnel module 250. The personnel module 250 may be configured to receive a work schedule from the automated schedule module 110 and/or the business metrics module 120. The personnel module 250 may also interact with the automated schedule module 110 and send information such as sick time, vacation days, and the like. In further embodiments, the personnel module 250 may enable personnel to confirm auxiliary staff. The personnel module 250 may also enable personnel to receive notifications of upcoming shifts, interactions with the manager, and other information relating to the business. In some embodiments, the personnel module 250 may interact and receive alerts from the business metrics module 120. For example, the personnel module 250 may receive work request alerts from the business metrics module 120 or may send and receive other alerts and/or message from the business metrics module 120.

In some embodiments, the remote device 215 may also communicate with the automated schedule module 110, the business metrics module 120, and other features and components of the location system 105-a via, for example, the network 205. The remote device 215 may be any of a number of electronic devices including, for example, a dedicated automation computing device (e.g., wall-mounted controller), a personal computing device (e.g., laptop, desktop, etc.), a mobile computing device (e.g., a tablet computing device, smartphone, etc.), and the like. The remote device 215 may be located physically away from the location system 105-a or components thereof such as, for example, the user interface 115. The remote device 215 may be accessed by, for example, a manager or other personnel associated with the place of business. The remote device 215 may be configured for two-way communication with the automated schedule module 110, the business metrics module 120, and other features of the location system 105-a. The remote device 215 may receive notifications and information associated with personnel, customers, scheduling, and the like (e.g., personnel data, work schedule, auxiliary staffing data, abnormal customer data, etc.). For example, the remote device 215 may contain a notification module 260. The notification module 260 may be configured to exchange alerts and/or message with the business metrics module 120. For example, the notification module 260 may receive alerts relating to customer data, scheduling parameters, inventory parameters, and the like

The personnel data 245 may be accessed directly from the database 220, from the personnel device 210 via, for example, the network 205 and/or the automated schedule module 110, the business metrics module 120, or other components of the location system 105-a. The personnel data 245 may be in the form of raw data such as, for example, staffing requirements, personnel profiles, and/or historical profit information. For example, the personnel profile may include information such as role, pay scale and a score associated with personnel. The personnel data 245 may also include more detailed information. For example, it may include staffing schedules and may record the punctuality, reliability, and performance of the personnel. For example, some personnel may be habitually late and constantly calling in sick. The personnel data 245 may record each instance and use the information to generate a score associated with the personnel. The personnel data 245 may also include information regarding performance. For example, the personnel may be consistently improving and taking on new roles at the business. The personnel may additionally cause an increase in sales or customer satisfaction.

In further embodiments, the business data 255 may be accessed directly from the database 220, from the personnel device 210 via, for example, the network 205 and/or the automated schedule module 110, the business metrics module 120, or other components of the location system 105-a. The business data 255 may be in the form of raw data such as, for example, customer purchases, customer movement, customers entering and exiting the business, and/or historical customer information. The business data 255 may also include more detailed information. For example, it may store data relating to number of customers onsite, online purchases, correlation between personnel and customer business, or the like. The business data 255 may record historical business information such as customer data and trends. The business data 255 may also include information correlating personnel to customer data. For example, some personnel may generate more revenue than others.

The remote device 215 may include a user interface, storage capability, and other features and functionalities that permit the remote device 215 to not only receive notifications and data, but to also send instructions, data, notifications, and the like. The remote device 215 may receive personnel profiles, staffing needs, automate a schedule, receive customer data, communicate with the location system 105-a, and store relevant information in a database (e.g., in database 220). The remote device 215 may also send notifications to the personnel device 210, the automated schedule module 110, the business metrics module 120, or other components of the location system 105-a, or to another location or remote device 215.

The network 205 provides communication via, for example, wired or wireless connections. Further, the network 205 may include a plurality of communication mediums. For example, the network 205 may include different communication mediums to provide communication between the automated schedule module 110, the business metrics module 120, and/or other components of the location system 105-a and other devices such as the personnel device 210, the remote device 215, and the database 220. Examples of the network 205 may include cloud networks, local area networks (LAN), wide area networks (WAN), virtual private networks (VPN), wireless networks (using 802.11, for example) and/or cellular networks (using 3G and/or LTE, for example), etc. In some embodiments, the network 205 may include the internet.

FIG. 3 is a block diagram 300 illustrating one example of an automated schedule module 110-a. The automated schedule module 110-a may be one example of the automated schedule module 110 depicted in FIGS. 1 and/or 2. As depicted, the automated schedule module 110-a may include an observation module 305, a learning module 310, a personnel profile module 315, a schedule module 320, an auxiliary module 325, and a publication module 330. Other embodiments may include additional or, in some embodiments, less modules than that which is shown in FIG. 3.

In some embodiments, the observation module 305 may observe personnel actions and scheduling. Personnel actions may include at least one of the performance, timeliness, and reliability. For example, the observation module 305 may observe clock-in and clock-out information. The observation module 305 may compare the clock-in and clock-out information with the scheduled shift times. The observation module 305 may record if the personnel is punctual, tardy, or the like. The observation module 305 may further track the consistent behavior of the personnel to note if personnel is habitually tardy or habitually punctual and may disregard sporadic tardy days for a habitually punctual personnel.

In some embodiments, the observation module 305 may also observe and/or record the performance of the personnel. For example, the personnel may cause an increase in business efficiency or sales. For example, in a restaurant business, the observation module 305 may notice a member of the wait staff consistently receives generous tips and positive feedback. In contrast, the observation module 305 may also observe a wait staff personnel who receives numerous complaints. In other embodiments, the observation module 305 may realize an increase in sales of consumer products or services associated or attributed to a particular personnel. The observation module 305 may also realize and observe advancing or improving skillset. For example, a beginner may make fewer mistakes or show a potential to increase their responsibilities.

In further embodiments, the observation module 305 may observe the reliability of personnel. For example, one or more personnel may consistently call in sick or have unscheduled emergencies and/or days off. In some instances, personnel may fail to call-in sick or otherwise notify the business of a pending absence. The observation module 305 may record the absences. For example, the observation module 305 may determine a particular personnel consistently calls in sick every third Thursday of the month. The absences may be observed and recorded to determine and may determine there is a pattern. Additionally, frequent absences may cause an alert to be sent to a manager.

The observation module 305 may additionally observe existing work scheduling practices. For example, the observation module 305 may observe shift start and end times, shift overlap, combinations of personnel scheduled, and the like. For example, the observation module 305 may determine the shift start and end times for specific personnel, specific roles scheduled, or a combination of both. Additionally, the shift start and end times may differ depending on day of the week, or other external factors such as seasonal changes. In some embodiments, combinations of personnel scheduled may include the different roles of the personnel scheduled and/or the actual personnel combinations that are scheduled. For example, the observation module 305 may determine the number of cashiers, wait staff, cooks, bartenders, or the like scheduled at a restaurant. The observation module 305 may also determine the specific personnel scheduled to work.

In some embodiments, the observation module 305 may compare the personnel and scheduling observations with a profit, efficiency, or other business metrics. For example, the observation module 305 may determine a specific combination of personnel roles leads to a greater profit during the scheduled shift. The specific combination of personnel may maximize efficiency while still meeting customer needs. In another embodiment, the observation module 305 may determine an increased profit or efficiency with a specific combination of personnel. The specific personnel may work more cohesively or effectively to the benefit of the business. For example, a specific combination of personnel at a construction site may work more effectively to finish the job at a faster rate, thus increasing the profits realized. The observation module 305 may also track an increase in sales when specific sales personnel work together on the sales floor.

Conversely, the observation module 305 may also determine when a combination of personnel decreases the efficiency or profitability of the business. For example, in some embodiments, a specific combination and number of personnel roles may decrease the efficiency or profitability of the business. For example, there may be too many cooks scheduled to work at a restaurant, or too many sales personnel on the sales floor. Additionally, the observation module 305 may observe when a combination of specific personnel leads to a decrease in efficiency or profitability. For example, two specific sales personnel may converse during their shift, ignoring customers. This may reflect a decrease in expected sales every time the two sales personnel are jointly scheduled. Additionally, in some instances, some personnel may have an abrasive relationship when scheduled jointly which may detrimentally affect the business. For example, two construction workers may bicker and not work cohesively to finish a building job or two line cooks may not function well together and may delay orders. The observation module 305 may observe and track this type of information.

In some embodiments, the observation module 305 may collect historical scheduling information or other information relating to the business. For example, the observation module 305 may receive information regarding historical shift scheduling, salary information, accounting information, personnel information and the like. The information may be uploaded into the observation module 305 or otherwise received and analyzed by the observation module 305. In further embodiments, the observation module 305 may collect historical information such as seasonal information, market information, or previous sales information. For example, the observation module 305 may observe market fluctuations based on external forces such as weather, world events, or the like. The observation module 305 may additionally observe and analyze previous sales information and may determine a pattern or other characteristics of pervious sales. In some embodiments, the information may be gathered and compared to other gathered data to determine correlations between work schedules, market fluctuations, seasonal impacts, and the like.

The learning module 310 may use the information from the observation module 305 to develop parameters and the like. For example, the learning module 310 may learn the scheduling needs of the business based on the observations and set forth certain parameters or rules for drafting and/or producing the work schedule and/or the shift requirements. The learning module 310 may optimize shift changes, or any necessary overlap between personnel for a cohesive business unit. Additionally, the learning module 310 may put rules in place where certain personnel are either to be scheduled together as frequently as possible or never be scheduled together.

As the learning module 310 becomes more sophisticated and refined, it may begin to implement changes. The changes may be acutely observed by the observation module 305 to determine their success or lack thereof. For example, the learning module 310 may increase or decrease staff based on a series of observations. The learning module 310 may implement this change and observe for a period of time before determining its success or failure. In some embodiments, the learning module 310 may automatically implement changes into the automated schedule module 110-a. In further embodiments, a manager may need to approve the changes before they are implemented. Further, the learning module 310 may only implement small, incremental changes, or may implement larger scale scheduling changes to optimize profit, efficiency, and other business metrics.

The personnel profile module 315 may record and retain profile information associated with personnel. The profile information may contain at least some information gathered by the observation module 305. For example, the personnel profile may include a score, pay scale, a role, and the like. The personnel score may track and evaluate individual personnel. The personnel score may be based at least in part on the personnel's attendance, proficiency, efficiency, profitability, timeliness, and the like. The personnel score may help the business determine the worth of the personnel and may also aid in scheduling. For example, it may not be desirable to schedule a shift consisting only of personnel with subpar ratings. Rather, it may be desirable to have a balanced number of personnel from multiple scoring levels. In further embodiments, personnel with superior ratings may receive more desirable shifts, an increased quantity in shifts, and the like. Additionally, personnel with superior ratings may receive bonuses, raises, or other forms of compensation.

In further embodiments, the personnel profile module 315 may contain pay scale information. For example, a personnel may have an hourly rate or some other quantifiable cost associated with them. This information may be stored within the personnel profile and may aid in creating a schedule. Other information which may be included in the personnel profile may include the personnel role, the proficiency of the personnel, the personnel's seniority, a profitability rating, and the like. A profitability rating may include either the ability of the personnel to make a sale, complete a job in an efficient manner, or some other quantifiable measure of profitability relating to the particulars of the business.

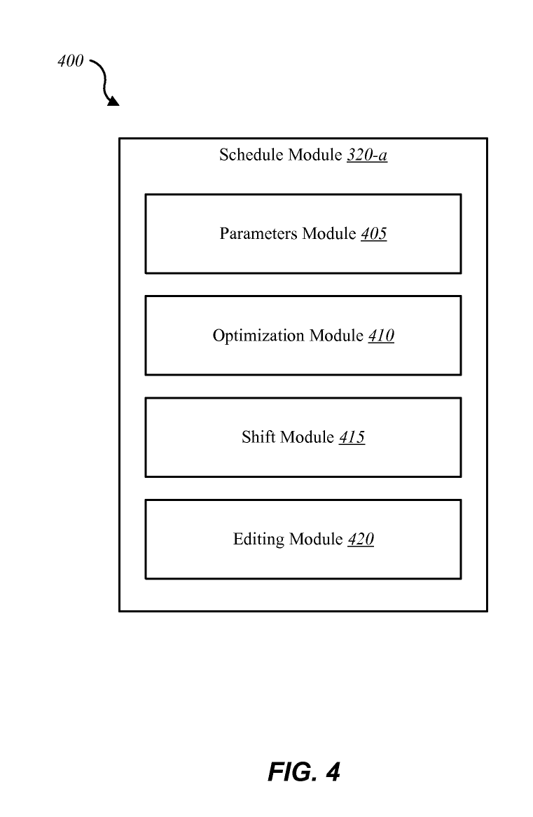

FIG. 4 is a block diagram 400 illustrating one example of a schedule module 320-a. The schedule module 320-a may be one example of the schedule module 320 displayed in FIG. 3. The schedule module 320-a may generate a work schedule for a business. The schedule may applicable to a number of industries and types of businesses or commercial locations. As depicted, the schedule module 320-a may include a parameters module 405, an optimization module 410, a shift module 415, and an editing module 420. Other embodiments may include additional or fewer capabilities than those illustrated in FIG. 4.

The parameters module 405 may be configured to set different parameters for each shift or each particular job of the business. Parameters may include minimum number of personnel, roles of personnel, profitability of the shift, and the like. The minimum number of personnel may combine with the personnel role to ensure every facet of the business is adequately staffed. For example, a business may require a number of personnel to pull supplies and then a different number of personnel to package supplies, and a third number of personnel to ship the packages. In another embodiment, a construction company may require a different number of masons, plumbers, electricians, etc. The number of each may vary depending on the size of the job, the location of the job, and the customer's parameters. In some embodiments, the time of day, or timing of the project may affect the scheduling parameters. For example, more electricians and plumbers may be needed one day, whereas the next, the business may require sheet-rockers. In other embodiments, the business may require different numbers or types of personnel depending on the time of day. For example, a restaurant/bar may require an increase in staffing during the dinner hour and then an additional increase in bartenders during the late evening, nighttime hours.

The parameters module 405 may also set rules such as specific personnel to group together or to separate. For example, the observation module 305 (FIG. 3) may determine a combination of personnel is more efficient or profitable and, conversely, another combination of personnel is detrimental to the success of the business. The parameters module 405 may set rules surrounding these individual personnel to maximize business profitability and efficiency. In some embodiments, the parameters module 405 may set a threshold for minimum personnel scheduled for each shift. The minimum personnel may be a correlation to historical information wherein the required personnel and the expected customer traffic maintains a predetermined ratio. In some embodiments, the number of customers present at the business may be tracked (e.g. by the customer data module 505) and may be compared to the number of personnel scheduled for the shift. If the customers exceeds the expected amount, or if the ratio of personnel to customers exceeds a threshold, an alert may be sent to a manager of the personnel. The alert may simply notify of an upcoming expected shortage, that the ratio has been exceed, or the like. In some embodiments, the manager may use an auxiliary module (e.g. auxiliary module 325) to locate auxiliary personnel to supplement the needs of the business.

The parameters module 405 may also set parameters for each shift wherein the parameters include at least a required number of personnel from predetermined score ranges. For example, the learning module 310 (FIG. 3) may determine and/or set predetermined personnel score ranges. The ranges may categorize personnel such as on a 1-10 scale or may set a naming categorization such as fundamental, novice, intermediate, advanced, and expert. The parameters module 405 may then have a required mixture or threshold of personnel from the different competencies. For example, every shift may be required to have at least one expert personnel in each personnel role scheduled. Or, only certain shifts may have this requirement, for example, a restaurant may require an expert chef for the lunch and/or dinner hours but may only require an advanced or intermediate chef scheduled during the slow business hours. In additional embodiments, the parameters module 405 may set a threshold of scores for shifts. For example, a shift may require a combined score such as 50. Then the personnel for the shift must have a combined score that meets or exceeds the score of 50. For example, scheduling 5 personnel for the shift with a score of 10 would meet the threshold. Other combinations of personnel and shift requirements may also meet the combined the score. The combined score or threshold may ensure the shift is adequately staffed to support the shift needs.

In further embodiments, the parameters module 405 may identify personnel scores within a predetermined range of scores. Personnel who have scores within the predetermined range may be scheduled for preferred shifts. For example, if personnel have a score ranging from 5-10, or intermediate—expert, may submit requests for their preferred shifts. The preferred shifts may be better working hours, more profitable shifts, or the like. The parameters module 405 may set parameters to provide preferential treatment to deserving personnel.

The optimization module 410 may review the requirements set in the parameters module 405 to ensure the schedule is optimized for profitability and efficiency. For example, the optimization module 410 may ensure certain personnel are not scheduled for overtime, or the overtime is limited to a profitable range. Additionally, the optimization module 410 may review a schedule to ensure the pay-scale of the personnel scheduled is optimized for efficiency and profitability. For example, the optimization module 410 may balance the personnel score with the personnel pay-scale. By balancing pay ranges with scores, the optimization module 410 may maximize profitability or other desirable business metrics.

In further embodiments, the optimization module 410 may balance the different ranges of personnel. For example, the optimization module 410 may determine a preferred range of personnel from different score ranges and/or rankings. The preferred range may be a combination of personnel to ensure beginner or novice personnel have the ability to learn from senior personnel. Additionally, the senior personnel may be adequately staffed to ensure the beginner or novice personnel receive adequate training while still achieving business goals.

The shift module 415 may create the shifts and compile a work schedule for the business. When creating the schedule, the shift module 415 may use the parameters module 405 and optimization module 410 to ensure the schedule created was optimized to meet the business needs. In some embodiments, the shift module 415 may additionally base the schedule off of personnel preferences. For example, personnel may have the ability to submit preferred shifts, preferred days off, preferred roles, and the like. The shift module 415 may consider the preferences when forming the shifts and overall work schedule. In some embodiments, preferential personnel (personnel with preferred scores) may receive their requests before other personnel. The shift module 415 may produce a work schedule for a predetermined time period. For example, the shift module 415 may produce a work schedule for a day, two days, a week, two weeks, etc. Once the shifts and schedules are created, the shift module 415 may send the schedule to a manager for approval.

The editing module 420 may enable the manager to edit and approve the work schedule created by the shift module 415. In further embodiments, any personnel associated with the business may edit and approve the work schedule. Manager is used generally herein. In some embodiments, the manager may manually make the changes to the schedule and approve it. In other embodiments, the manager may request the schedule module 320-a to redo the schedule based on certain parameters and/or feedback. If a business has multiple managers, the editing module 420 may enable the responsible managers to edit and review only their shifts. However, the schedule module 320-a may coordinate with other managers to ensure all staffing needs are met. Once all edits and approvals are received, the editing module 420 may produce a final work schedule. Conversely, the editing module 420 may relay information to the shift module 415, which may produce a final work schedule.

In some embodiments, a manager's actions may also be observed and recorded (by, for example, the observation module 305, FIG. 3). If manager shows preferential or discriminatory treatment of personnel, the manager may receive a warning. In some embodiments, these actions may cause the schedule module 320-a to alert the manager's supervisor concerning their actions.

Returning back to FIG. 3, the auxiliary module 325 may produce a list of auxiliary shift options. The auxiliary shift options may include at least a list of acceptable auxiliary personnel. The auxiliary personnel may be general auxiliary personnel or may be specific to particular roles and job functions of the personnel. In some embodiments, a scheduled personnel may have access to the list. For example, the auxiliary module 325 may publish and/or send the list to the scheduled personnel, manager, and the like. If a scheduled personnel is incapable of working, the personnel may contact an auxiliary personnel asking if they will work the upcoming shift. In some embodiments, the scheduled personnel and auxiliary personnel may interact using the personnel module 250 on the personnel devices 210. The auxiliary personnel may respond either affirmatively or negatively to the response. If the auxiliary personnel negatively responds, the scheduled personnel may continue polling the auxiliary personnel. Once an auxiliary personnel has positively responded, the substitute request may be sent for approval. In some embodiments, a manager may then have the option of approving or rejecting the request. If the request is approved, the schedule module 320 may receive a notification and update the schedule. If the request is rejected, the scheduled personnel may need to continue polling auxiliary personnel until an acceptable auxiliary personnel is located, confirmed, and approved.

In further embodiments, the list of shift auxiliary options may be published to a manager. The manager may access the auxiliary shift options to request personnel to work when the business experiences an increase in activity. For example, the business may have an increase in customers, sales, or other events that may require the need of additional personnel. The manager may use the list of auxiliary shift options to augment staffing to satisfy the business needs. In some embodiments, the manager may send a work request to the auxiliary personnel. For example, the manager may use the remote device 215 to send a request to the personnel device 210. The personnel may access the request using the personnel module 250 located within the personnel device 210. The personnel may then send a response back to the manager. The response may be positive or negative. If the response is negative, the manager may continue to contact auxiliary personnel until an auxiliary personnel affirmatively responds.

In some embodiments, the publication module 330 may publish a finalized and approved work schedule. If an auxiliary personnel has been requested to work, the publication module 330 may immediately update and publish the new schedule. The publication may be limited to managers, select personnel, or may be published and distributed to the business as a whole. In some embodiments, the schedule may be electronic and personnel may receive an email, text message, or the like containing the schedule. In other embodiments, personnel may access the schedule via the personnel module 250 on the personnel device 210 (FIG. 2). For example, the latest scheduling information may be accessible via a mobile application which may be downloaded to the personnel device 210.

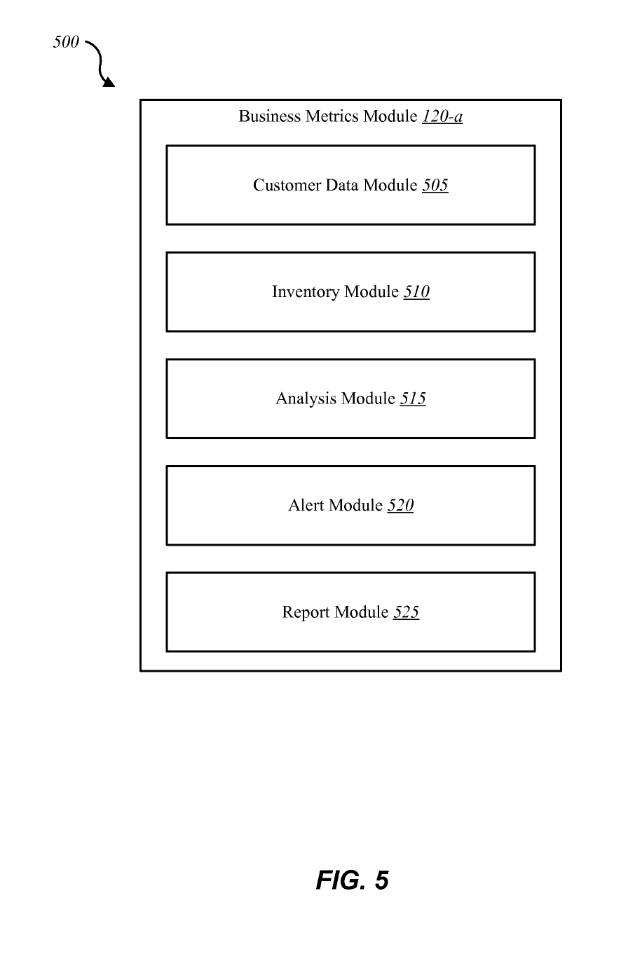

FIG. 5 is a is a block diagram 500 illustrating one example of a business metrics module 120-a. The business metrics module 120-a may be one example of the business metrics module 120 depicted in FIGS. 1 and/or 2. As depicted, the business metrics module 120-a may include a customer data module 505, an inventory module 510, an analysis module 515, an alert module 520, and a report module 525. Other embodiments may include additional or, in some embodiments, fewer modules than that which is shown in FIG. 5.

In some embodiments, the customer data module 505 may track, receive, and or record customer data. For example, the customer data module 505 may be equipped to receive information regarding customer traffic. The customer traffic may include a number and direction of customers. The direction of customers may include whether customers are entering or exiting a location associated with a business. The customer direction information may also track the movement of customers once they enter a location. For example, the customer data module 505 may determine how many customers are present at the location and where the customers are located or traveling within the location. For example, in some instances, a stream of customers may be entering the store and heading to a sale section, or only purchasing milk. The customer data module 505 may track all this information. In some embodiments, the customer data module 505 may coordinate with an onsite security system or other such surveillance system. The customer data module 505 may either use one or more cameras associated with the onsite system to track customer movement or may receive information from an onsite system relaying customer information.

The customer data module 505 may also track point of sale information. For example, the customer data module 505 may record data regarding customer's purchases including time of day, itemized purchases, correlation to events or sales, payment options, coupons, discounts, and the like. The customer data module 505 may correlate the purchases to determine a pattern of purchases. In further embodiments, the customer data module 505 may correlate sales and purchases to specific personnel.

In some embodiments, the inventory module 510 may track inventory associated with a business. The inventory may be tangible or intangible goods. For example, the inventory may be tangible inventory such as goods or may intangible inventory such as services. If the inventory is tangible, the inventory module 510 may track purchases and/or shipping associated with inventory. In some embodiments, the inventory levels may be compared to historical sales information to ensure the business has adequate supplies to fulfill customer needs. In some embodiments, inventory may be special ordered for specific events or work orders. The special order inventory may be tracked separately to ensure the inventory is not misused or misplaced. If the inventory module 510 tracks soft inventory, the inventory module 510 may track service contracts to ensure adequate personnel to complete the job. For example, service contracts may include legal work, accounting work, marketing work, and the like. The inventory module 510 may ensure adequate staff and time to complete the job and not overbook or double-book personnel.

In further embodiments, the inventory module 510 may set inventory parameters for upcoming time periods. For example, the inventory module 510 may reference historical information to determine and set parameters for ordering inventory for upcoming time periods. The parameters may set a required number of specific inventory to have onsite or at a particular location for an upcoming time period. The historical information may also relate to seasonal information and may set parameters to phase out certain types of inventory and to begin ordering new inventory. Seasonal inventory may relate to food items, clothing items, school items, holiday items, and the like.

In some embodiments, the analysis module 515 may gather, interpret and/or analyze information relating to the business. For example, the analysis module 515 may receive and/or gather information relating to inventory data and customer data (e.g. information from the customer data module 505 and/or the inventory module 510). In further embodiments, the analysis module 515 may also have information from the automated schedule module 110. For example, the analysis module 515 may have shift information, personnel profile information, schedule information, and the like. The analysis module 515 may compare customer data to information from the automated schedule module 110 such as scheduling parameters. In some embodiments, the analysis module 515 may determine if the customer data exceeds one or more scheduling parameters of the business. For example, scheduling parameters may include a ratio of personnel to customers present at the business. The ratio may also be personnel to orders, deliveries, or other business requirements. The ratio may include overall personnel to customers or may be specific to particular personnel roles (e.g. wait staff, hostess, bartender, cook, etc.). If the ratio is exceeded, an alert may be sent using the alert module 520 (discussed below).

To determine the number of customers present at a business, the analysis module 515 may have customer traffic information. For example, the analysis module 515 may pull customer traffic information from the customer data module 505. The customer traffic information may include a number of customers and direction (e.g. whether the customer is entering or exiting the business). Using this information, the analysis module 515 may calculate, approximate, or gauge the number of customers present in the business at any given time. This may be calculated for regular intervals. For example, at the end of a business date, the analysis module 515 may generate a graph of the amount of customers present at the business location throughout the day. In other embodiments, the analysis module 515 may actively monitor the number of customers present at the business. In still further embodiments, the analysis module 515 may calculate the number of customers present at a location at specific intervals such as every 10 minutes, every half hour, hourly, bi-daily, daily, etc.

The analysis module 515 may also realize unpredicted changes in customer data. For example, the analysis module 515 may have information gathered by the customer data module 505. The analysis module 515 may compare the actual, gathered information to the predicted information. In some embodiments, the analysis module 515 may realize an unpredicted shift in the customer data. For example, the customer data may exceed historical information and more customers may arrive or orders may be placed. Conversely, customer traffic and orders may be lower or less plentiful than predicted. The analysis module 515 may realize this information and request input. For example, the analysis module 515 may request information from at least one personnel associated with the business to correlate the unpredicted change in customer data. The correlation may be an external event. For example, the correlation may be a conference, a sales event, a product release, inclement weather, a social event, or the like. These types of events may sway customer traffic and/or orders either positively or negatively. In some embodiments, the personnel may respond with specific information as to why the business experienced the change. For example, the information request may contain a series of responses and a check box wherein the personnel may select the most appropriate response. In further embodiments, the request for information may be open-ended and allow the personnel to report relevant information. The information may be recorded and referred to for future use. For example, the recorded information may cause a realization in new customer trends. The new customers trends may relate to specific events concerning the business.

In further embodiments, the analysis module 515 may also gather inventory information. For example, the analysis module 515 may have inventory information and correlate the inventory information to information gathered by the customer data module 505 or, in some embodiments, the automated schedule module 110. The analysis module 515 may correlate customer information to inventory information to determine which inventory customers purchase more of, or which products customers tend to purchase together. The comparisons and correlations may result in inventory ordering parameters, marketing material, inventory display, and the like. The inventory ordering parameters correlation to customer data may enable a business to optimize for minimal but sufficient inventory on hand. In some embodiments, inventory parameters may include a minimum amount of select inventory to have on hand.

The analysis module 515 may also determine any trends between the point of sale information, customer data, and work schedule information. The analysis module 515 may develop trends correlating or attempting to find a relationship between the data. For example, there may be a spike in point of sales when certain customer thresholds are met. In further embodiments, certain personnel may have increased sales or decreased sales. The fluctuation in sales may result in capture the trend between profits or losses of the business and the work schedule information. Additionally, there may be trends that develop between select personnel and sales or revenue. In additional embodiments, inventory parameters may result in greater profit due to the lower overhead of maintaining store inventory and proper ordering techniques and timing. For example, in a restaurant, fewer perishable items may need to be disposed because the inventory is efficiently maintained to ensure client needs are met while minimizing waste.

The alert module 520 may facilitate alerts based on the above described modules and parameters. For example, the alert module 520 may generate and push alerts to various personnel including managers. For example, the alert module 520 may generate an alert when the customer to personnel ratio is inadequate. The alert may be sent to a manager or other personnel. In some embodiments, the alert module 520 may request an action by the manager. The action may be to approve the inadequacies, or to begin the process to request auxiliary personnel to supplement business needs. The alert module 520 may also generate and/or send alerts as thresholds are encroached or exceeded. For example, if an unexpected increase in customers occurs, the alert module 520 may send an alert to a manager regarding the status of the threshold. The status may be that the threshold is about to be exceed or is approaching its limitations. The parameters may be customer parameters, inventory parameters, personnel or staffing parameters. In some embodiments, alerts may be sent to more than one manager or personnel. For example, the alert may be sent to specific shift managers as well as their supervisor. In some embodiments, if inventory is low, the alert may request the manager to access emergency supplies or likewise supplement inventory. For example, a restaurant may have had a higher than expected order of eggs for breakfast. Or, perhaps a refrigerator was not closed properly and supplies need to be replaced. The alerts may send these request to managers and request action.

The report module 525 may generate and send out reports based on the information contained within the business metrics module 120-a and sometimes the comparisons between business metrics and employee scheduling from the automated schedule module 110. For example, the report module 525 may generate reports tracking customer data, inventory data, profits, losses, and the like. The reports may be historical, forward looking, or for recent time periods. The reports may be automatically generated or personnel may request specific reports to be run. The reports may also realize business metric trends to better enable personnel to maximize business profit, or other business goals such as sustainability, reusability, friendliness, and the like. The reports may also correlate business metrics to scheduling information to better align the two modules to meet business goals.

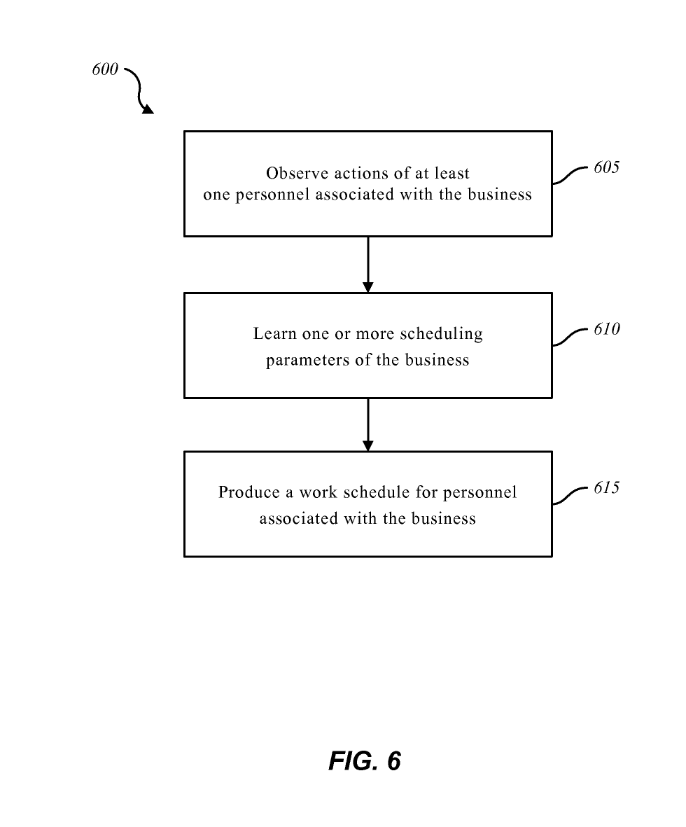

FIG. 6 is a flow diagram illustrating one embodiment of automating work schedule for a business. In some configurations, the method 600 may be implemented by the automated schedule module 110 of the location system 105 shown in FIGS. 1 and/or 2. In other examples, the method 600 may be performed generally by the location system 105 shown in FIGS. 1 and/or 2, or even more generally by the environments 100, 200 shown in FIGS. 1 and/or 2.

At block 605, actions of at least one personnel associated with the business may be observed. For example, one or more personnel may be observed based on their performance, timeliness, reliability and the like. The personnel's arrival and departure times or clock-in and clock-out times may be compared to the scheduled time to determine if the personnel is consistently punctual or tardy. Additionally, the personnel's absences may be observed as well as whether the personnel gave adequate notice for the pending absences. If a particular personnel consistently calls in sick right before their shift starts, the personnel may be flagged as unreliable. In contrast, if a personnel is usually on time for their shift but occasionally gives adequate notice prior to absences, the personnel may be seen as reliable.

In some embodiments, historical information regarding the business may also be observed. For example, seasonal information, market information or previous sales information may be gathered and stored. The information may provide an insight into the functions and fluctuations of the business to provide more well-rounded knowledge. In some embodiments, historical scheduling information may also be observed. For example, historical or previous scheduling information may be input into the system. The historical information may speed up the observation process to provide an automated schedule system. The historical information may reduce the observation and learning period to achieve an automated scheduling system sooner.

In some embodiments, the scheduled personnel and scheduling may be compared to the business metrics. For example, the impact of the personnel, their interaction and scheduling may affect business metrics such as efficiency, profit, waste, sales royalties, customer loyalty, overhead, loss, hours worked per process, and the like. Other aspects of the business may also be observed and recorded. For example, if weather affects the business, severe weather conditions may be tracked such as severe thunderstorms, snowstorms, tornadoes, earthquakes, etc. Additionally, newsworthy events may be observed and recorded if they may impact the particular business. For example, an e. coli outbreak in beef products may impact other producers of unaffected beef may still be negatively impacted by the news. All these type of external events that have the potential to negatively or positively impact the business may be observed and recorded.

At block 610, one or more scheduling parameters of the business may be learned. This may be based on the observations gathered at block 605. For example, all of the observations concerning personnel actions and scheduling may be compared to business metrics and external events to improve scheduling to positively impact the business. For example, a specific number of personnel may result in positive business metrics and reduce waste or loss. The specific number may be a combination of different personnel roles. In some embodiments, a scheduled mixture of personnel expertise may also benefit the business. The mixture of expertise may result in lower overhead costs while still achieving business goals. Additionally, the timing of shift changes or shift overlap may also benefit the business.

At block 615, a work schedule for personnel associated with the business may be produced. The schedule may be based on the learning at block 610 and/or the observations at block 605. The schedule may include a predetermined time period. For example, the schedule may be for the next day, week, two weeks, month, etc. The predetermined time period may be set by the manager, other personnel, or, in some embodiments, if no time period is set, it may default to two weeks.

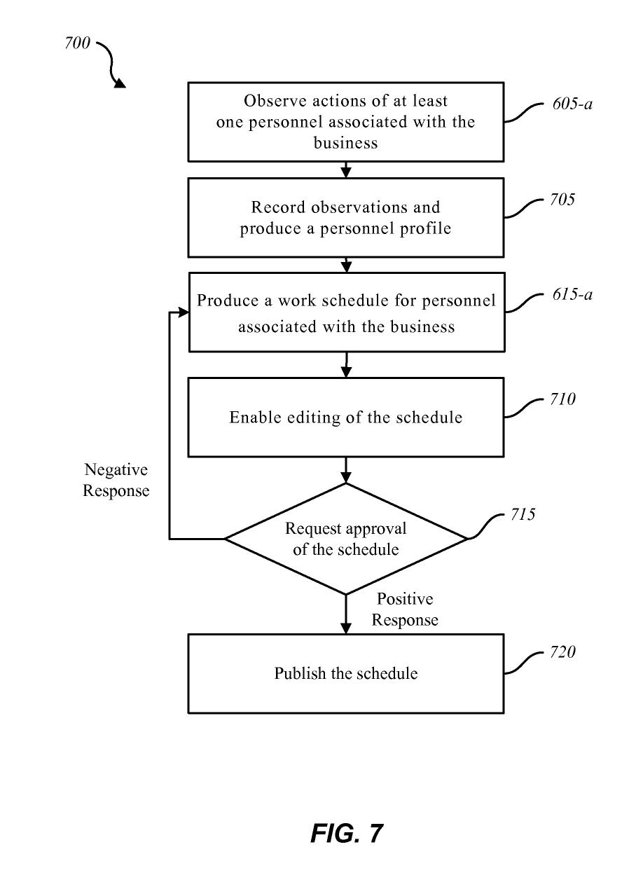

FIG. 7 is a flow diagram illustrating an embodiment of another method 700 for automating personnel scheduling. In some configurations, the method 700 may be implemented by the automated schedule module 110 of the location system 105 shown in FIGS. 1 and/or 2. In other examples, the method 700 may be performed generally by the location system 105 shown in FIGS. 1 and/or 2. Even still more generally, the method 700 may be performed generally by the environments 100, 200 shown in FIGS. 1 and/or 2.

At block 605-a, the personnel actions and scheduling may be observed. Then, at block 705, the observations may be recorded and personnel profile may be produced. For example, in some embodiments, the observations may be used to generate a personnel profile. The personnel profile may include the personnel's contact information, role, experience, number of sick days taken, number of vacations taken, achieved skill levels, pay-scale, and the like. In some embodiments, the personnel profile may also include a personnel score. For example, the personnel may have a rating based on their performance among other factors. The rating may reflect amount of experience, skills, absences, efficiency, or some combination thereof. The rating may also reflect additional information relevant to the personnel's performance or pay-scale. Each factor may have an individual factor score or rating. The factor score may be summed up to a total score, or may be averaged into an overall score. For some business, the score may be a numeric score. It may be on a small scale, such as 1-10, or may be on a much higher scale such as 1-100. In other embodiments, the rating may be a series of named levels such as beginner, novice, intermediate, advanced, and expert. Different scoring methods may be available. In some embodiments, the scoring methods may be unique and customized to particular businesses.

At block 615-a, a work schedule for personnel associated with the business may be produced. The schedule may be based upon the personnel score. For example, personnel with preferential scores may receive more desirable shifts, working hours, or vacation days. In some embodiments, the schedule may contain shifts with personnel of predetermined skill levels. For example, the shift may include five personnel, and at least one personnel may be from the “expert” range, and only one personnel may be from the “beginner” range. By varying the expertise and/or rating of the personnel, the schedule may maximize business metrics and personnel learning. For example, the schedule may balance the expertise and/or ranking of the personnel with the pay-scale associated with the personnel to maximize for business profit. Additionally, by using the different rankings and ratings, the schedule may prevent scheduling multiple unreliable personnel for the same shift. This may prevent an understaffed shift due to multiple absences. In some embodiments, a manager or other personnel associated with the business may set the personnel score distribution or requirements for each shift.

At block 710, the schedule may be edited. For example, the schedule created at block 615-a may be published only to select personnel such as a manager. The manager may have the ability to change aspects of the schedule. In some embodiments, any aspect of the schedule may be changed or edited. For example, staffing for shifts may be increased or decreased. The timing of shifts or the personnel scheduled may be changed. In some embodiments, no changes may be necessary.

Once the editing is complete, at block 715, the approval of the schedule may be requested. If the schedule is rejected, a new schedule may be created at block 615-a. For example, the schedule may be rejected and a request for a new schedule may be generated. In other embodiments, the rejection may provide feedback as to why the schedule was rejected so a more desirable schedule can be produced. In some embodiments, an overall schedule change request or specific changes to the schedule may be requested. Changes may be observed and recorded as part of a learning module (e.g. learning module 310). In other embodiments, the changes may be requested due to pending events. For example, the business may have an upcoming event such as a party reservation at a restaurant, an increase in sales due to a convention or product release, or some other event. This feedback may be provided with the rejection and a new schedule may be generated at block 615-a.

If the schedule is approved, at block 720, the schedule may be published. For example, the schedule may be electronic and may be distributed to various business personnel. The schedule may be distributed via text message, email, online, and the like. In some embodiments, the schedule may be sent to a mobile device associated with the personnel (e.g., personnel device 210 and/or remote device 215). For example, the mobile device may have an application which may access the schedule. In further embodiments, a hard copy of the schedule may be created and distributed to personnel.

In some embodiments, other steps of method 700 may include portions of the method 600. In other embodiments, the method 700 may include receiving requesting time-off from personnel. For example, the personnel may submit requested vacation days or specific days off. The schedule may be additionally based on these personnel preferences.

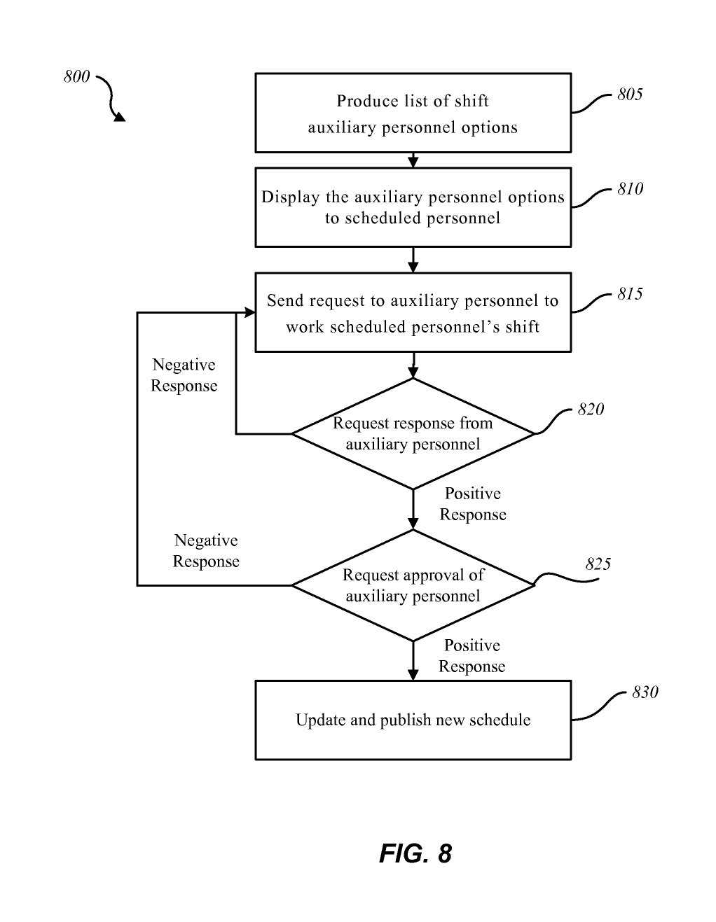

FIG. 8 is a flow diagram illustrating an embodiment of a method 800 for finding auxiliary personnel. In some configurations, the method 800 may be implemented by the automated schedule module 110 of the location system 105 shown in FIGS. 1 and/or 2. In other examples, the method 800 may be performed generally by the location system 105 shown in FIGS. 1 and/or 2. Even still more generally, the method 800 may be performed generally by the environments 100, 200 shown in FIGS. 1 and/or 2. In some embodiments, other steps of method 800 may include portions of the method 600 and/or 700.

At block 805, a list of shift auxiliary personnel options may be produced. For example, when the schedule is generated, certain personnel may not be scheduled to work but may be listed as available to work. The list of shift auxiliary personnel may include alternative personnel to replace a scheduled personnel. The list may be specific to personnel roles. For example, the list may be specific to cooks, wait staff, carpenters, electricians, etc. Each role within a business may be defined and the list may include alternative personnel for each shift. In some embodiments, the lists may only contain desirable personnel. For example, if personnel have a score associated with them, the list may only comprise personnel who have achieved and/or maintained a certain score or proficiency level or surpassed a threshold. In still further embodiments, the list of auxiliary personnel may be specific to the scheduled personnel. For example, the list may only contain alternative personnel with the same ranking and/or proficiency level with the same personnel role. Additionally, the list may be specific for the shift or may be a generic auxiliary list for any timeframe. In some embodiments, if the list is a generic list, personnel may need to achieve a predetermined proficiency level or score in order to join the list.

At block 810, the auxiliary personnel options may be displayed to the scheduled personnel. For example, the list may be electronic and may be distributed to scheduled personnel. If the list is a generic list, it may be generally distributed and always available. The electronic list may be distributed and/or available via email, online, or via a mobile phone. For example, an application downloaded onto a mobile device may access the list of auxiliary personnel. In other embodiments, the list may be printed and available in a hardcopy. The hardcopy may be displayed onsite at the business, or may be distributed among personnel.

At block 815, if a personnel has a conflict and cannot work, the personnel may send a request to an auxiliary personnel to work the scheduled personnel's shift. For example, the scheduled personnel may be unable to work and may view the list of auxiliary personnel. The scheduled personnel may contact auxiliary personnel and ask the auxiliary personnel to fill in. The request may be sent via the mobile application on the personnel's mobile devices, or may be sent via other means such as a phone call, email, SMS, or the like. At block 820, a response from the auxiliary personnel may be requested. If the auxiliary personnel provides a negative response, at block 815, the scheduled personnel may start the process over.

However, if the auxiliary personnel provides a positive response, at block 825, an approval for the auxiliary personnel may be requested. For example, an approval request may be sent to a manager of the scheduled personnel. If the auxiliary personnel is not approved, the scheduled personnel may need to start the process over at block 815. For example, the auxiliary personnel may not have the same proficiency level or skillset as the scheduled personnel. The auxiliary personnel may also extend into overtime pay, which may cause the rejection of the auxiliary personnel. Other reasons for rejecting the request may also exist. Feedback may be provided to enable the scheduled personnel to find a better suited auxiliary. If the request is approved, at block 830, the schedule may be updated and a new schedule may be published.

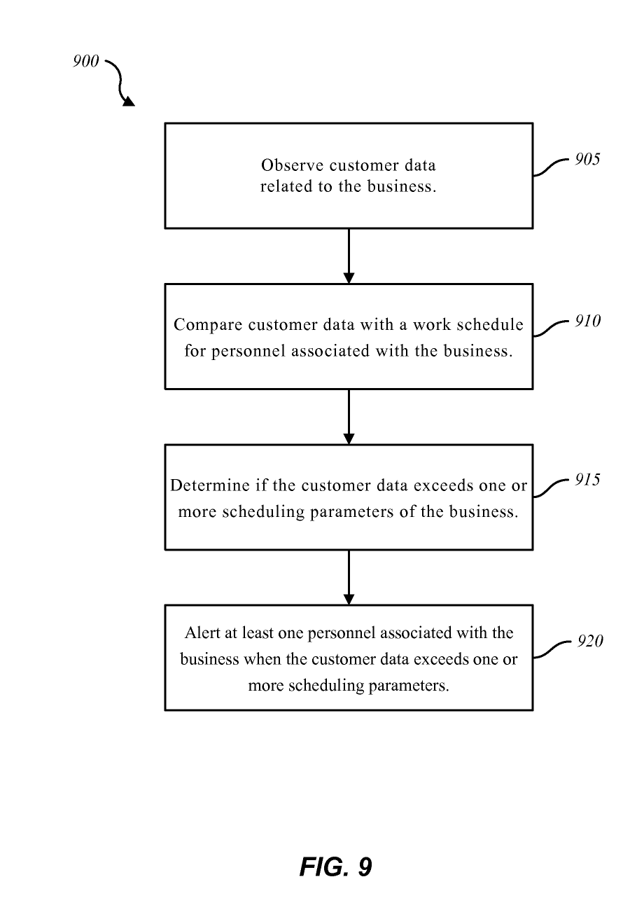

FIG. 9 is a flow diagram illustrating an embodiment of a method 900 for automating business metric tracking. In some configurations, the method 900 may be implemented by the business metrics module 120 of the location system 105 shown in FIGS. 1 and/or 2. In other examples, the method 900 may be performed generally by the location system 105 shown in FIGS. 1 and/or 2. Even still more generally, the method 900 may be performed generally by the environments 100, 200 shown in FIGS. 1 and/or 2. In some embodiments, other steps of method 900 may include portions of the methods 600, 700, and/or 800.

At block 905, customer data related to the business may be observed. The customer data may include at least one of a number of customers, customer purchases, or customer traffic. For example, the movement of customers may be observed via one or more cameras present at a location. The movement and number of customers may be used to determine a number of customers present at a business location. Point of sale information may also be observed and recorded. The point of sale information may include time of day, cashier, sales clerk, items, relationship between items, sale or coupons, and the like. Additionally, demographic information may be collected. For example, receipts may contain survey information. The survey information may allow additional information and demographics to be collected regarding the customers to augment and develop a better understanding of clientele.

At block 910, the customer data may be compared with a work schedule for personnel associated with the business. In some embodiments, the work schedule may be based upon one or more scheduling parameters. For example, the work schedule may be created using one or more parameters. The parameters may include at least a ratio between number of customers present at a business and personnel scheduled to work. The parameters may also include a minimum number of personnel to satisfy business needs, and may be specific to personnel roles. For example, a restaurant may have a required number of cooks, chefs, wait staff, bartenders, hostesses and the like. The scheduling parameters may include requirements for each of these roles based on time of day, day of the week, season, events, etc. Additionally, specific personnel may be required depending upon the scheduling parameters. For example, if a certain client made a reservation or requested a particular personnel, the personnel may need to be scheduled. For example, a client may have requested a specific stylist for their hair, shopping needs, or other personal care needs. In other embodiments, an organizer of an event may have requested specific chefs and wait staff for their event. The scheduling parameters may contain this information and compare the information to customer data.

At block 915, it may be determined if the customer data exceeds one or more scheduling parameters of the business. For example, if scheduling parameters are exceeded, an alert may be generated and sent to a manager or other personnel associated with the business. Multiple parameters may also be tracked and/or exceed in some instances. For example, an increase in customers may exceed wait staff and kitchen staff thresholds. Conversely, if patrons use the bar versus the dining room, bartender thresholds may be exceeded. In other instances, customers data such as customer orders may exceed personnel needed to fulfill the orders. The orders may be associated with deliveries or packing supplies. Alerts may additionally be generated if inventory parameters are exceeded. For example, if inventory is running low or excessive inventory is present, the manager may receive an alert notifying them of the shortage and/or surplus. In some embodiments, a correlation between personnel and inventory shortage may be realized. For example, a particular personnel may be found to be taking inventory supplies for personal use.

At block 920, at least one personnel associated with the business may be alerted when the customer data exceeds one or more scheduling parameters. In some embodiments, the alert may be sent to a manager of the business. For example, an alert may be generated and sent to a mobile device associated with the personnel. The alert may be an email, ping, SMS, voicemail or the like. The alert may relate when certain thresholds have been or exceed or when thresholds are reaching their limit. Alerts may additionally contain information regarding scheduling issues, unusual or unpredicted customer fluctuations, inventory parameters and the like. Alerts may also include information regarding staffing shortage. The staffing shortage may be a result of absent personnel, increase in customer activity, or the like. In some embodiments, the alerts may automatically be generated to auxiliary personnel to replace absent staff or to augment staffing to satisfy business needs.

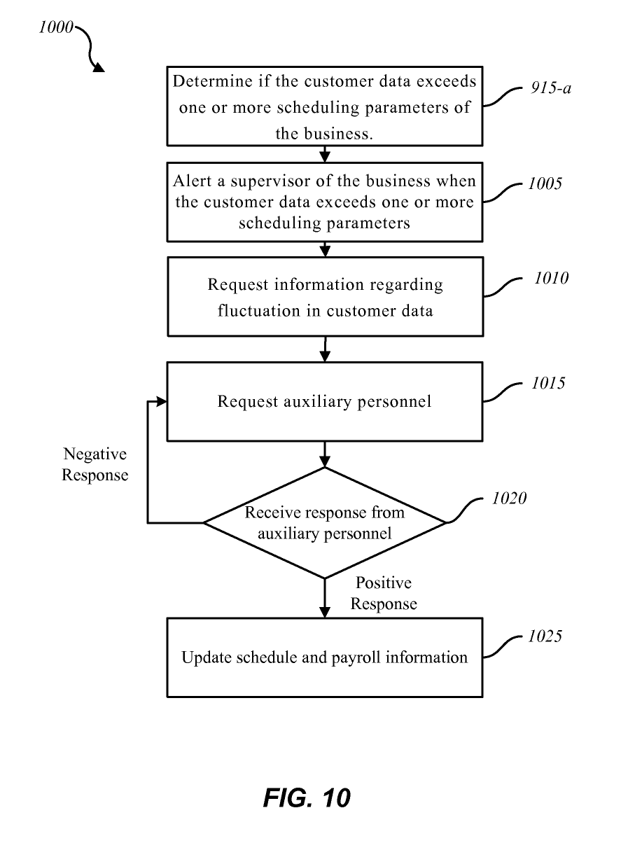

FIG. 10 is a flow diagram illustrating an embodiment of a method 1000 for automating business metric tracking. In some configurations, the method 1000 may be implemented by the business metrics module 120 of the location system 105 shown in FIGS. 1 and/or 2. In other examples, the method 900 may be performed generally by the location system 105 shown in FIGS. 1 and/or 2. Even still more generally, the method 900 may be performed generally by the environments 100, 200 shown in FIGS. 1 and/or 2. In some embodiments, other steps of method 900 may include portions of the method 600, 700, 800, and/or 900.

At block 915-a, it may be determined if the customer data exceeds one or more scheduling parameters of the business. Then, at block 1005, a supervisor of the business may be alerted when the customer data exceeds one or more scheduling parameters. For example, an alert may be generated and sent to a mobile device associated with the supervisor. The alert may be an email, ping, SMS, voicemail or the like. The alert may relate when certain thresholds have been met or exceeded or when thresholds are reaching their limit. Alerts may additionally contain information regarding scheduling issues, unusual or unpredicted customer fluctuations, inventory parameters and the like. Inventory parameters may include excessive or inadequate inventory, surplus in specific supplies or specials, missing inventory or unexpected delivery of additional inventory. Additionally, some inventory may be ordered automatically. Alerts may be generated alarming the manager of pending orders and/or when the orders have been place and consequently shipped. Alerts may also include information regarding staffing shortage. The staffing shortage may be a result of absent personnel, increase in customer activity, or the like.

At block 1010, information regarding the fluctuation in customer data may be requested. For example, if, at block 915-a, a fluctuation in customer data is realized that affects scheduling parameters, more information may be requested to determine the cause of the fluctuation. The information may be recorded in a historical database (e.g. business data 255). The information may be used to continuously update and modify scheduling parameters and other business metrics. To request information, a message may be sent to personnel associated with the business. The message may be a voice message, ping, SMS, email, or the like. The message may contain a multiple choice list wherein the personnel may select reasoning or may be an open form wherein the personnel may enter relevant information. Depending upon the reasoning, during the same time period in the following year, the personnel may receive a message asking if the event was likely to reoccur. For example, maybe the fluctuation was in relation to a conference. During the next annual period, a request may be sent to personnel asking if the conference has been scheduled again. The information may help to update and ensure adequate personnel for the business period.

At block 1015, if there is a fluctuation in customer data and one or more thresholds have been exceed, auxiliary personnel may be requested. For example, a manager or other personnel may receive an alert stating the current status of the business and list the need for auxiliary personnel. In some embodiments, the need for personnel may be ranked. The ranking may be rated such as low, medium, high or may have numerical correlations such as 1-10. The ranking may allow a supervisor to determine which auxiliary personnel to request as backup. For example, once a supervisor realizes the need for auxiliary personnel, they may send a request to the personnel. The request may ask the personnel to arrive to the business within a certain time frame and to work for a certain length of time.

At block 1020, the auxiliary personnel may provide a response. The response may be a negative response. If the response is negative, the method may return to block 1015 where additional auxiliary personnel may be requested to work. If the response is positive, at block 1025, the schedule and payroll information may be updated. For example, a new schedule may be generating and published. The new schedule may alert managers, or other personnel of an auxiliary personnel. The updated schedule may contain a name for the auxiliary personnel, shift time, and the like. The schedule may then in turn update payroll and other business metric information. For example, the personnel profile may be updated to reflect the positive feedback on the auxiliary personnel and also track overtime hours and the like.

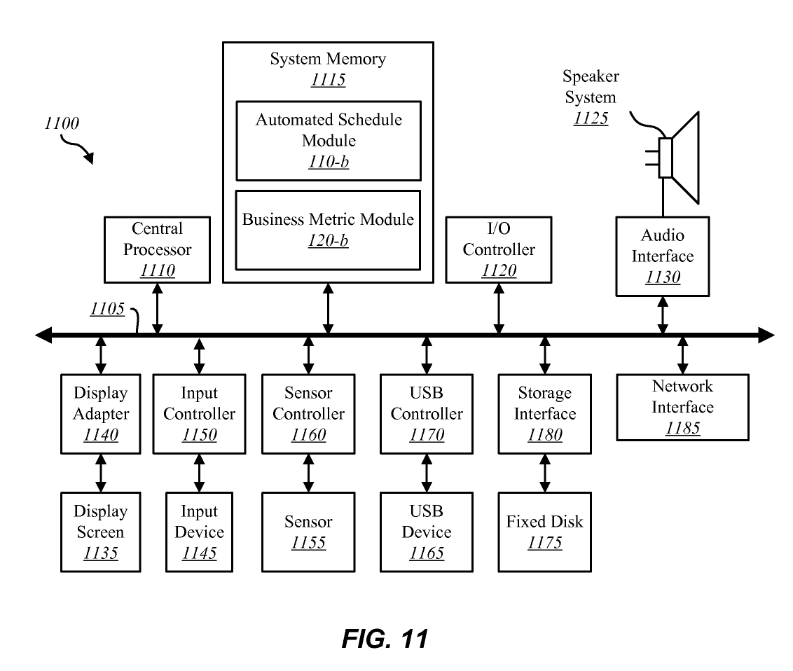

FIG. 11 depicts a block diagram of a computer system 1100 suitable for implementing the present systems and methods. The computer system 1100 may be an example of the mobile computing device 225, the remote device 215, the personnel device 210, the database 220, and/or some combination thereof illustrated in FIG. 2. In one configuration, the computer system 1100 may include a bus 1105 which interconnects major subsystems of the computer system 1100, such as a central processor 1110, a system memory 1115 (typically RAM, but which may also include ROM, flash RAM, or the like), an input/output controller 1120, an external audio device, such as a speaker system 1125 via an audio output interface 1130, an external device, such as a display screen 1135 via display adapter 1140, an input device 1145 (e.g., remote control device interfaced with an input controller 1150), multiple USB devices 1165 (interfaced with a USB controller 1170), and a storage interface 1180. Also included are at least one sensor 1155 connected to bus 1105 through a sensor controller 1160 and a network interface 1185 (coupled directly to bus 1105).

The bus 1105 may allow data communication between the central processor 1110 and the system memory 1115, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an automated schedule module 110-b and/or a business metrics module 120-b to implement the present systems and methods may be stored within the system memory 1115. Applications (e.g., application 230) resident with the computer system 1100 are generally stored on and accessed via a non-transitory computer readable medium, such as a hard disk drive (e.g., fixed disk drive 1175) or other storage medium. Additionally, applications can be in the form of electronic signals modulated in accordance with the application and data communication technology when accessed via the network interface 1185.

The storage interface 1180, as with the other storage interfaces of the computer system 1100, can connect to a standard computer readable medium for storage and/or retrieval of information, such as a fixed disk drive 1175. The fixed disk drive 1175 may be a part of the computer system 1100 or may be separate and accessed through other interface systems. The network interface 1185 may provide a direct connection to a remote server via a direct network link to the Internet via a POP (point of presence). The network interface 1185 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., documents scanners, digital cameras, and so on). Conversely, all of the devices shown in FIG. 11 need not be present to practice the present systems and methods. The devices and subsystems can be interconnected in different ways from that shown in FIG. 11. The aspect of some operations of a system such as that shown in FIG. 11 are readily known in the art and are not discussed in detail in this application. Code to implement the present disclosure can be stored in a non-transitory computer-readable medium such as one or more of system memory 1115 or fixed disk drive 1175. The operating system provided on the computer system 1100 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method to automate metric tracking for a business, comprising:
observing customer data related to the business, the customer data comprising at least one of a number of customers, customer purchases, or customer traffic;
comparing the observed customer data with a work schedule for personnel associated with the business, the work schedule being based at least in part on one or more scheduling parameters of the business; and
determining if the observed customer data exceeds the one or more scheduling parameters of the business; and
alerting at least one personnel associated with the business based at least in part on the determining when the customer data exceeds the one or more scheduling parameters.

2. The computer-implemented method of claim 1, wherein alerting the at least one personnel further comprises:
alerting a supervisor of the business based on the determining step when the customer data exceeds the one or more scheduling parameters.

3. The computer-implemented method of claim 1, further comprising:
capturing customer traffic, wherein at least one video camera installed at the business captures images of customer movement;
determining customer movement from the capturing, wherein the movement comprises entering or exiting the business;
gauging the number of customers present at the business based on the determining.

4. The computer-implemented method of claim 3, further comprising:
setting scheduling parameters, wherein the parameters comprise at least a ratio of the personnel associated with the business and the number of customers present at the business.

5. The computer-implemented method of claim 1, further comprising:
recording the customer data based on the observing;
generating reports based on the recording; and
distributing the reports to at least one personnel associated with the business.

6. The computer-implemented method of claim 5, further comprising:
developing one or more scheduling parameters and one or more inventory parameters for pending time periods based on the reports.

7. The computer-implemented method of claim 1, further comprising:
identifying an unpredicted change in the customer data, wherein the change comprises one of a fluctuation in the customer traffic or the customer purchases;
requesting information from at least one personnel associated with the business to correlate the unpredicted change in customer data with an external event; and
recording the unpredicted change in a database with the correlating external event information.

8. The computer-implemented method of claim 7, wherein the external event is one of a conference, a sale event, a product release, inclement weather, or a social event.

9. The computer-implemented method of claim 7, furthering including
reviewing the database for historical information;
generating a report to send to at least one personnel associated with the business, wherein the report contains the historical information for an upcoming time period.

10. The computer-implemented method of claim 1, further comprising:
comparing the customer data to an inventory database; and
developing one or more inventory parameters based on the comparison.

11. The computer-implemented method of claim 1, furthering comprising:
producing a list of shift auxiliary options, the shift auxiliary options comprising at least a list of acceptable auxiliary personnel;
displaying the options to a supervisor of the auxiliary personnel; and
receiving a notification that an acceptable auxiliary personnel agreed to work.

12. The computer implemented method of claim 1, further comprising
capturing point of sale data, wherein the point of sale data includes items purchased, cost of items purchased, and relationship of items purchased to each other;
comparing the point of sale information to the work schedule;
determining one or more trends between the point of sale data and the work schedule, wherein the one or more trends capture profits or losses of the business.

13. An apparatus to automate metric tracking for a business, comprising:
a processor;
a memory in electronic communication with the processor; and
instructions stored in the memory, the instructions being executable by the processor to:
observe customer data related to the business, the customer data comprising at least one of a number of customers, customer purchases, or customer traffic;
compare the customer data with a work schedule for personnel associated with the business, the work schedule being based at least in part on one or more scheduling parameters;
determine if the customer data exceeds the one or more scheduling parameters of the business; and
alert at least one personnel associated with the business based at least in part on the determining when the customer data exceeds the one or more scheduling parameters.

14. The apparatus of claim 13, wherein the instructions are executable by the processor to:
set scheduling parameters, wherein the parameters comprise at least a ratio of personnel associated with the business and the number of customers present at the business.

15. The computer-implemented method of claim 13, wherein the instructions are executable by the processor to:
capture the customer traffic, wherein at least one video camera installed at the business captures images of customer movement;
determine customer movement from the capturing, wherein the movement comprises entering or exiting the business;
gauge the number of customers present at the business based on the determining.

16. The apparatus of claim 13, wherein the instructions are executable by the processor to:
identify an unpredicted change in the customer data, wherein the changes comprise one of unpredicted fluctuation in the customer traffic or unpredicted fluctuation in customer purchases;
request information from at least one personnel associated with business to correlate the unpredicted change in the customer data with an external event; and
record the unpredicted change in a database with correlating external event information.

17. The apparatus of claim 13, wherein the instructions are executable by the processor to:
producing a list of shift auxiliary options, the shift auxiliary options comprise at least a list of acceptable auxiliary personnel;
displaying the options to a supervisor of the auxiliary personnel; and
receiving a notification that an acceptable auxiliary personnel agreed to work.

18. A computer-program product to automate metric tracking for a business, the computer-program product comprising a non-transitory computer-readable medium storing instructions executable by a processor to:
observe customer data related to the business, the customer data comprising at least one of a number of customers, customer purchases, or customer traffic;
compare the customer data with a work schedule for personnel associated with the business, the work schedule being based at least in part on one or more scheduling parameters;
determine if the customer data exceeds the one or more scheduling parameters of the business; and
alert at least one personnel associated with the business based at least in part on the determining when the customer data exceeds the one or more scheduling parameters.

19. The computer-program product of claim 18, wherein the instructions are executable by the processor to:
identify an unpredicted change in the customer data, wherein the changes comprise one of unpredicted fluctuation in customer traffic or unpredicted fluctuation in customer purchases;
request information from at least one personnel associated with the business to correlate the unpredicted change in the customer data with an external event; and
record the unpredicted change in a database with correlating external event information.

20. The computer-program product of claim 18, wherein the instructions are executable by the processor to:
set scheduling parameters, wherein the parameters comprise at least a ratio of personnel associated with the business and number of customers present at the business.
